(19) United States
(12) Patent Application Publication
(10) Pub. No.: US 2023/0092675 A1
(43) Pub. Date: Mar. 23, 2023

(54) CATHODE MATERIAL AND PROCESS

(71) Applicant: JOHNSON MATTHEY PUBLIC LIMITED COMPANY, London (GB)

(72) Inventors: Jessica HILL, Billingham (GB); Stuart JOHNSON, Billingham (GB); Olivia Rose WALE, Reading (GB)

(21) Appl. No.: 17/787,029

(22) PCT Filed: Dec. 15, 2020
(86) PCT No.: PCT/GB2020/053212

§ 371 Date: Jun. 17, 2022

(30) Foreign Application Priority Data
Dec. 18, 2019 (GB) 1918699.8

(51) Int. Cl. H01M 4/525; C01G 53/00

(52) U.S. Cl. CPC H01M 4/525; C01G 53/42; C01P 2002/54; C01P 2006/40; C01P 2002/60; C01P 2002/72; H01M 2004/028

(57) ABSTRACT

A process for producing a lithium nickel metal oxide material is provided together with a particulate lithium nickel metal oxide material with a defined crystallite size. Such materials find utility as cathode materials for secondary lithium-ion batteries. The process comprises a first calcination step which comprises heating at a temperature of between about 460° C. and about 540° C. for a period of between three and ten hours, and a subsequent second calcination step which comprises heating to a temperature greater than about 600° C. for a period of between 30 mins and 4 hours.

### FIELD OF THE INVENTION

The present invention relates to lithium nickel metal oxide materials, and to improved processes for making lithium nickel metal oxide materials, which have utility as cathode materials in secondary lithium-ion batteries.

### BACKGROUND OF THE INVENTION

Lithium nickel metal oxide materials having a layered structure find utility as cathode materials in secondary lithium-ion batteries. High nickel content in such materials (e.g. greater than 70 mol %) can lead to a high discharge capacity, but such materials may suffer from poor electrochemical stability, for example after repeated charge-discharge cycles. The inclusion of varying amounts of other metals can improve electrochemical stability. However, the inclusion of non-nickel elements can lead to a reduction in discharge capacity.

Typically, lithium nickel metal oxide materials are produced by mixing a nickel metal hydroxide precursor with a source of lithium, and then calcining the mixture to form the desired layered crystalline structure. During the calcination process, the nickel metal hydroxide reacts with the lithium and undergoes transformation of the crystal structure via intermediate phases to form the desired layered LiNiO₂ structure. Simultaneously, primary crystals sinter together leading to growth in crystallite size. Formation of the desired crystalline phase is typically carried out by holding the material at a high temperature (at least 700° C.) for an extended period of time to ensure complete phase transformation. This high temperature hold requires a high energy consumption on a manufacturing scale.

For example, WO2013/025328A2 describes a method of making lithium nickel metal oxide materials. Example 1 describes the preparation of Li_{1.05}Mg_{0.025}Ni_{0.92}Co_{0.08}O_{2.05}. A precursor material (Ni_{0.92}Co_{0.08}(OH)₂) is mixed with Li(OH)₂, LiNO₃ and Mg(OH)₂. The mixture is then heated at a rate of 5° C. per minute to about 450° C., and held at about 450° C. for about 2 hours. The temperature is then raised at about 2° C. per minute to about 700° C. and held for about 6 hours.

WO2017/189887A1 describes a method of manufacturing an electrochemically active particle, the method comprising the production of a first mixture comprising lithium hydroxide or its hydrate and a precursor hydroxide comprising nickel, and calcining the first mixture to a maximum temperature of 700° C. Example 1 describes the preparation of two samples of polycrystalline 2D α-NaFeO₂-type layered structure particles. A precursor hydroxide is mixed with LiOH and then heated from 25° C. to 450° C. at 5° C. per minute with a soak time of 2 hours followed by a second ramp at 2° C. per minute to a maximum temperature of 700° C. (or 680° C.) for a soak time of 6 hours.

There remains a need for improved processes for making lithium nickel metal oxide materials, and for lithium nickel metal oxide materials with improved electrochemical properties.

### SUMMARY OF THE INVENTION

The present inventors have found that the formation of the desired lithium nickel oxide crystalline phase may be achieved by a calcination process involving a calcination step at a temperature of between about 460° C. and about 540° C., and then a subsequent calcination step at a temperature above 600° C. The process as described herein offers a reduction in the time required at high temperature during the formation of lithium nickel metal oxide materials and therefore a reduction in energy consumption. The herein described process can also lead to the formation of lithium nickel metal oxide materials with improved electrochemical properties, such as a reduced internal resistance and a higher discharge capacity.

Accordingly, in a first aspect of the invention there is provided a process for producing a lithium nickel metal oxide material having a composition according to Formula 1:

LiₐNiₓCo_{y}A_{z}O_{2+b} Formula 1
in which:
A is one or more of Al, V, Ti, B, Zr, Cu, Sn, Cr, Fe, Ga, Si, Zn, Mg, Sr, Mn, and Ca;
0.8≤a≤1.2
0.7≤x<1
0<y≤0.3
0≤z≤0.2
−0.2≤b≤0.2
x+y+z=1
the process comprising the steps of:
(i) mixing a nickel metal hydroxide precursor with a lithium-containing compound; and
(ii) calcining the mixture to form the lithium nickel metal oxide material;
wherein the calcination comprises a first calcination step which comprises heating at a temperature of between about 460° C. and about 540° C. for a period of between three and ten hours, and a subsequent second calcination step which comprises heating to a temperature greater than about 600° C. for a period of between 30 mins and 4 hours.

In a second aspect of the invention there is provided a particulate lithium nickel metal oxide material obtained or obtainable by a process as described herein

Analysis and testing of materials produced by the method as described herein has identified a variation in the crystallite size produced during different calcination profiles, and that materials within a certain crystallite size range offer reduced internal resistance and improved discharge capacities.

Therefore, in a third aspect of the invention there is provided a material having a composition according to Formula 2:

Liₐ₁Niₓ₁Co_{y1}A_{z1}O_{2+b1} Formula 2
in which:
A is one or more of V, Ti, B, Zr, Cu, Sn, Cr, Ga, Si, Mg, Sr and Ca;
0.8≤a1≤1.2
0.7≤x1<1
0<y1<0.3
0<z1≤0.2
−0.2≤b1≤0.2
x1+y1+z1=1
wherein the particulate lithium nickel metal oxide has a crystallite size of from 90 to 200 nm.

The materials as described herein have utility as cathode materials in secondary lithium-ion batteries. Therefore, in a fourth aspect of the invention there is provided an electrode comprising a material according to the third aspect or obtained or obtainable by a process according to the first aspect. In a fifth aspect of the invention there is provided an electrochemical cell comprising an electrode according to the fourth aspect.

### BRIEF DESCRIPTION OF THE DRAWINGS

FIG. 1 shows the results from an in situ XRD experiment showing changes in phases present during a calcination including a 500° C. hold.

FIG. 2 shows the results of electrochemical C-rate testing of Examples 1 to 7.

FIG. 3 shows the results of electrochemical capacity retention testing of Examples 1 to 7.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The present invention provides a process for the production of lithium nickel metal oxide materials having a composition according to Formula I as defined above.

In Formula I, 0.8≤a≤1.2. It may be preferred that a is greater than or equal to 0.9, or greater than or equal to 0.95. It may be preferred that a is less than or equal to 1.1, or less than or equal to 1.05. It may be preferred that 0.90≤a≤1.10, for example 0.95≤a≤1.05. It may be preferred that a=1.

In Formula I, 0.7≤x<1. It may be preferred that 0.75≤x<1, 0.8≤x<1, 0.85≤x<1 or 0.9≤x<1. It may be preferred that x is less than or equal to 0.99, 0.98, 0.97, 0.96 or 0.95. It may be preferred that 0.75≤x≤1, for example 0.75≤x≤0.99, 0.75≤x≤0.98, 0.75≤x≤0.97, 0.75≤x≤0.96 or 0.75≤x≤0.95. It may be further preferred that 0.8≤x<1, for example 0.8≤x≤0.99, 0.8≤x≤0.98, 0.8≤x≤0.97, 0.8≤x≤0.96 or 0.8≤x≤0.95. It may also be preferred that 0.85≤x<1, for example 0.85≤x≤0.99, 0.85≤x≤0.98, 0.85≤x≤0.97, 0.85≤x≤0.96 or 0.85≤x≤0.95.

In Formula 1, 0<y≤0.3. It may be preferred that y is greater than or equal to 0.01, 0.02 or 0.03. It may be preferred that y is less than or equal to 0.2, 0.15, 0.1 or 0.05. It may also be preferred that 0.01≤y≤0.3, 0.02≤y≤0.3, 0.03≤y≤0.3, 0.01≤y≤0.25, 0.01≤y≤0.2, 0.01≤y≤0.15, 0.01≤y≤0.1 or 0.03≤y≤0.1.

A is one or more of Al, V, Ti, B, Zr, Cu, Sn, Cr, Fe, Ga, Si, Zn, Mg, Sr, Mn and Ca. It may be preferred that A is not Mn, and therefore that A is one or more of Al, V, Ti, B, Zr, Cu, Sn, Cr, Fe, Ga, Si, Zn, Mg, Sr, and Ca. It may be further preferred that A is one or more of V, Ti, B, Zr, Cu, Sn, Cr, Ga, Si, Mg, Sr and Ca. Preferably, A is at least Mg and/or Al, or A is Al and/or Mg. More preferably, A is Mg. Where A comprises more than one element, z is the sum amount of each of the elements making up A.

In Formula I, 0≤z≤0.2. It may be preferred that 0≤z≤0.15, 0≤z≤0.10, 0≤z≤0.05, 0≤z≤0.04, 0≤z≤0.03, or 0≤z≤0.02, or that z is 0.

In Formula I, −0.2≤b≤0.2. It may be preferred that b is greater than or equal to −0.1. It may also be preferred that b is less than or equal to 0.1. It may be further preferred that −0.1≤b≤0.1, or that b is 0 or about 0.

It may be preferred that 0.8≤a≤1.2, 0.75≤x<1, 0<y≤0.25, 0≤z≤0.2, −0.2≤b≤0.2 and x+y+z=1. It may also be preferred that 0.8≤a≤1.2, 0.75≤x<1, 0<y≤0.25, 0≤z≤0.2, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, Mn and Ca. It may also be preferred that 0.8≤a≤1.2, 0.75≤x<1, 0<y≤0.25, 0≤z≤0.2, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, and Ca.

It may be preferred that 0.8≤a≤1.2, 0.8≤x<1, 0<y≤0.2, 0≤z≤0.2, −0.2≤b≤0.2 and x+y+z=1. It may also be preferred that 0.8≤a≤1.2, 0.8≤x<1, 0<y≤0.2, 0≤z≤0.2, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, Mn and Ca. It may also be preferred that 0.8≤a≤1.2, 0.8≤x<1, 0<y≤0.2, 0≤z≤0.2, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, and Ca.

It may be preferred that 0.8≤a≤1.2, 0.85≤x<1, 0<y≤0.15, 0≤z≤0.15, −0.2≤b≤0.2 and x+y+z=1. It may also be preferred that 0.8≤a≤1.2, 0.85≤x<1, 0<y≤0.15, 0≤z≤0.15, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, Mn and Ca. It may also be preferred that 0.8≤a≤1.2, 0.85≤x<1, 0<y≤0.15, 0≤z≤0.15, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, and Ca.

It may be further preferred that the lithium nickel metal oxide has a formula according to Formula 2:

Liₐ₁Niₓ₁Co_{y1}A_{z1}O_{2+b1} Formula 2
in which:
A is one or more of V, Ti, B, Zr, Cu, Sn, Cr, Ga, Si, Mg, Sr and Ca;
0.8≤a1≤1.2
0.7≤x1<1
0<y1<0.3
0<z1≤0.2
−0.2≤b1≤0.2
x1+y1+z1=1

In Formula 2, A is one or more of V, Ti, B, Zr, Cu, Sn, Cr, Ga, Si, Mg, Sr and Ca. It may be preferred that A is Mg and optionally one or more of V, Ti, B, Zr, Cu, Sn, Cr, Ga, Si, Sr and Ca. It is further preferred that A=Mg.

In Formula 2, 0.8≤a1≤1.2. It may be preferred that a1 is greater than or equal to 0.9, or greater than or equal to 0.95. It may be preferred that a1 is less than or equal to 1.1, or less than or equal to 1.05. It may be preferred that 0.90≤a1≤1.10, for example 0.95≤a1≤1.05, or that a1=1.

In Formula 2, 0.7≤x1<1. It may be preferred that 0.75≤x1<1, 0.8≤x1<1, 0.85≤x1<1 or 0.9≤x1<1. It may be preferred that x1 is less than or equal to 0.99, 0.98, 0.97, 0.96 or 0.95. It may be preferred that 0.75≤x1<1, for example 0.75≤x1≤0.99, 0.75≤x1≤0.98, 0.75≤x1≤0.97, 0.75≤x1≤0.96 or 0.75≤x1≤0.95. It may be further preferred that 0.8≤x1<1, for example 0.8≤x1≤0.99, 0.8≤x1≤0.98, 0.8≤x1≤0.97, 0.8≤x1≤0.96 or 0.8≤x1≤0.95. It may also be preferred that 0.85≤x1<1, for example 0.85≤x1≤0.99, 0.85≤x1≤0.98, 0.85≤x1≤0.97, 0.85≤x1≤0.96 or 0.85≤x1≤0.95.

In Formula 2, 0<y1<0.3. It may be preferred that y1 is greater than or equal to 0.01, 0.02 or 0.03. It may be preferred that y1 is less than 0.2, 0.15, 0.1 or 0.05. It may also be preferred that 0.01≤y1<0.3, 0.02≤y1<0.3, 0.03≤y1<0.3, 0.01≤y1≤0.25, 0.01≤y1≤0.2, 0.01≤y1≤0.15, 0.01≤y1≤0.1 or 0.03≤y1≤0.1.

In Formula 2, 0<z1≤0.2. It may be preferred that 0<z1≤0.15, 0<z1≤0.10, 0<z1≤0.05, 0<z1≤0.04, 0<z1≤0.03, or 0<z1≤0.02.

In Formula 2, −0.2 b1≤0.2. It may be preferred that b1 is greater than or equal to −0.1. It may also be preferred that b1 is less than or equal to 0.1. It may be further preferred that −0.1≤b1≤0.1, or that b1 is 0, or about 0.

It may be preferred that 0.8≤a1≤1.2, 0.75≤x1<1, 0<y1<0.25, 0<z1≤0.2, −0.2≤b1≤0.2 and x1+y1+z1=1. It may be further preferred that 0.8≤a1≤1.2, 0.75≤x1<1, 0<y1<0.25, 0<z1≤0.1, −0.2≤b1≤0.2 and x1+y1+z1=1.

It may be preferred that 0.8≤a1≤1.2, 0.8≤x1<1, 0<y1<0.2, 0<z1<0.2, −0.2≤b1≤0.2 and x1+y1+z1=1. It may be further preferred that 0.8≤a1≤1.2, 0.8≤x1<1, 0<y1<0.2, 0<z1≤0.1, −0.2≤b1≤0.2 and x1+y1+z1=1.

It may be preferred that 0.8≤a1≤1.2, 0.85≤x1<1, 0<y1<0.15, 0<z1<0.15, −0.2 b1≤0.2 and x1+y1+z1=1. It may be further preferred that 0.8≤a1≤1.2, 0.85≤x1<1, 0<y1<0.15, 0<z1≤0.1, −0.2≤b1≤0.2 and x1+y1+z1=1.

Preferably, the particulate lithium nickel metal oxide material according to Formula 2 as defined above has a crystallite size in the range of and including 90 to 200 nm. Such materials may offer a reduced internal resistance in comparison with materials with a crystallite size <90 nm. Increasing crystallite size to greater than 200 nm may lead to a reduction in the rate of lithium ion diffusion and reduced initial capacity. It may be further preferred that the particulate lithium nickel metal oxide material according to Formula 2 as defined above has a crystallite size of from 90 to 190 nm, 90 to 180 nm, 90 to 170 nm, 90 to 160 nm, 90 to 150 nm, 90 to 140 nm, 90 to 130 nm. It may be further preferred that the particulate lithium nickel metal oxide material according to Formula 2 as defined above has a crystallite size of 90 to 120 nm. Such materials offer particularly high discharge capacity.

It may also be preferred that the particulate lithium nickel metal oxide material according to Formula 2 as defined above has a crystallite size of 110 to 200 nm, 110 to 190 nm, or 110 to The crystallite size is determined using a Rietveld analysis of the powder x-ray diffraction pattern of the lithium nickel metal oxide material.

The lithium nickel metal oxide material is a crystalline or substantially crystalline material. It may have the α-NaFeO₂-type structure.

Typically, the lithium nickel metal oxide material is in the form of secondary particles which comprise a plurality of primary particles (made up from one or more crystallites). Such secondary particles typically have a D50 particle size of at least 1 μm, e.g. at least 2 μm, at least 4 μm or at least 5 μm. The particles of lithium nickel metal oxide typically have a D50 particle size of 30 μm or less, e.g. 20 μm or less, or 15 μm or less. It may be preferred that the particles of surface-modified lithium nickel metal oxide have a D50 of 1 μm to 30 μm, such as between 2 μm and 20 μm, or 5 μm and 15 μm. The term D50 as used herein refers to the median particle diameter of a volume-weighted distribution. The D50 may be determined by using a laser diffraction method (e.g. by suspending the particles in water and analysing using a Malvern Mastersizer 2000).

The process as described herein comprises a first step of mixing a nickel metal hydroxide precursor with a lithium-containing compound.

It may be preferred that the nickel metal hydroxide precursor comprises a compound according to Formula 3:

[Niₓ₂Co_{y2}A_{z2}][Oₚ(OH)_{q}]_{α} Formula 3

wherein:
A is one or more of Al, V, Ti, B, Zr, Cu, Sn, Cr, Fe, Ga, Si, Zn, Mn, Mg, Sr, and Ca;
0.7≤x2≤1
0≤y2≤0.3
0≤z2≤0.2
wherein p is in the range 0≤p<1; q is in the range 0<q≤2; x2+y2+z2=1; and α is selected such that the overall charge balance is 0.

Preferably, p is 0, and q is 2. In other words, preferably the nickel metal hydroxide precursor is a pure metal hydroxide having the general formula [Niₓ₁Co_{y1}A_{z1}][(OH)₂]_{α}.

As discussed above, α is selected such that the overall charge balance is 0. α may therefore satisfy 0.5≤α≤1.5. For example, α may be 1. Where A includes one or more metals not having a +2 valence state, or not present in a +2 valence state, a may be other than 1.

It will be understood by the skilled person that the values x2, y2, and z2, and the element(s) A, are selected so as to achieve the desired composition in Formula 1 after the process as described herein.

For example, the nickel metal hydroxide precursor may be a compound of formula Ni_{0.90}Co_{0.05}Mg_{0.05}(OH)₂, Ni_{0.90}Co_{0.06}Mg_{0.04}(OH)₂, Ni_{0.90}Co_{0.07}Mg_{0.03}(OH)₂, Ni_{0.91}Co_{0.08}Mg_{0.01}(OH)₂, Ni_{0.88}Co_{0.08}Mg_{0.04}(OH)₂, Ni_{0.90}Co_{0.08}Mg_{0.02}(OH)₂, or Ni_{0.93}Co_{0.06}Mg_{0.01}(OH)₂.

The nickel metal hydroxide precursor may be in particulate form. The nickel metal hydroxide precursor may be prepared by a process known in the art, for example by (co-) precipitation of nickel metal hydroxides by the reaction of metal salts with sodium hydroxide under basic conditions.

Typically, the nickel metal hydroxide precursor is in powder form, the powder comprising particles of precursor having a volume average particle size D50 of from 2 to 50 μm, suitably 2 to 30 μm, suitably 5 to 20 μm, suitably 8 to 15 μm.

The lithium-containing compound comprises lithium ions and a suitable inorganic or organic counter-ion. Suitably the lithium source comprises one or more lithium compounds selected from lithium carbonate, lithium oxide, lithium hydroxide, lithium chloride, lithium nitrate, lithium sulfate, lithium hydrogen carbonate, lithium acetate, lithium fluoride, lithium bromide, lithium iodide and lithium peroxide. It may be preferred that the lithium source is selected from one or more of lithium carbonate and lithium hydroxide. It may be further preferred that the lithium source is lithium hydroxide. The present invention may provide particular advantages where the lithium source is lithium hydroxide. Lithium hydroxide is a particularly suitable lithium source where the lithium transition metal oxide material contains low levels of manganese (for example less than 10 mol %, less than 5 mol %, or less than 1 mol %, with respect to moles of transition metal in the lithium nickel metal oxide material), and/or does not contain any manganese.

The mixture of the nickel metal hydroxide precursor with a lithium-containing compound is then subjected to a calcination comprising a first calcination step which comprises heating at a temperature of between about 460° C. and about 540° C. for a period of between three and ten hours.

The first calcination step typically includes a heating stage during which the temperature is increased, and a hold phase during which the temperature is maintained at an elevated level. The hold phase of the first calcination step may be performed at a temperature of between 460 to 540° C., 470 to 530° C., 480 to 520° C., 490 to 510° C., or about 500° C.

The hold phase of the first calcination step is performed for a period of between three and ten hours, such as between three and nine hours, three and eight hours, four and eight hours, or five and seven hours.

During the heating phase of the first calcination step, the temperature may be increased at a rate of 1° C./min to 20° C./min, for example 2° C./min to 10° C./min, such as 3° C./min to 8° C./min.

The calcination comprises a second calcination step which comprises heating at a temperature greater than about 600° C. The second calcination step typically includes a heating stage during which the temperature is increased, and a hold phase during which the temperature is maintained at an elevated level. The hold phase of the second calcination step may be performed at a temperature of at least 600° C., at least 625° C., at least 650° C., at least 670° C. or at least 680° C. The hold phase of the second calcination step is typically performed at a temperature of 1000° C. or less, 900° C. or less, 850° C. or less, 800° C. or less, or 750° C. or less. For example, the hold phase of the second calcination step may be performed at a temperature in the range of 600 to 1000° C., 600 to 800° C., 650 to 800° C., 650 to 750° C., or 670 to 750° C.

The hold phase of the second calcination step is performed for a period of 30 mins or more, such as 1 hour or more, or 1.5 hours or more. The hold phase of the second calcination step is performed for a period of 4 hours or less, such as 3 hours or less. For example, the hold phase of the second calcination step may be performed for a period of between 30 mins and 4 hours, such as for a period of between 1 hour and 4 hours, or 1.5 and 3 hours.

For example, the second calcination step may be carried out at a temperature in the range from 600 to 800° C. for a period of between 30 mins and 4 hours, such as for a period of between 1 and 4 hours.

During the heating phase of the second calcination step, the temperature may be increased at a rate of 1° C./min to 20° C./min, for example 1° C./min to 10° C./min, such as 1° C./min to 5° C./min.

It may be preferred that the calcination comprises a first calcination step which comprises heating to a temperature of between about 460° C. and about 540° C. for a period of between three and ten hours and a second calcination step which comprises heating to a temperature of between about 600 to about 800° C. for a period of between thirty mins and four hours, such as for a period of between one and four hours.

It may be further preferred that the calcination comprises (i) heating at a rate of 1° C./min to 20° C./min to a temperature of between about 460° C. and about 540° C.; (ii) holding at a temperature of between about 460° C. and about 540° C. for a period of between three and ten hours (iii) increasing the temperature to at least 600° C. at a rate of 1° C./min to 20° C./min; (iv) holding at a temperature in the range from 600 to 800° C. for a period of 30 mins to 4 hours.

The calcination may be carried out in any suitable furnace known to the person skilled in the art, for example a static kiln (such as a tube furnace or a muffle furnace), a tunnel furnace (in which static beds of material are moved through the furnace, such as a roller hearth kiln or push-through furnace), or a rotary furnace (including a screw-fed or auger-fed rotary furnace). The furnace used for calcination is typically capable of being operated under a controlled gas atmosphere. It may be preferred to carry out the calcination step in a furnace with a static bed of material, such as a static furnace or tunnel furnace (e.g. roller hearth kiln or push-through furnace). It is preferred that the calcination is carried out in a single furnace. This may provide benefits in process economics.

Where the calcination is carried out in a furnace with a static bed of material, the mixture of nickel metal hydroxide precursor and lithium-containing compound is typically loaded into a calcination vessel (e.g. saggar or other suitable crucible) prior to the high temperature calcination.

The calcination step may be carried out under a CO₂-free atmosphere. The CO₂-free air may, for example, be a mix of oxygen and nitrogen. Preferably, the atmosphere is an oxidising atmosphere. As used herein, the term “CO₂-free” is intended to include atmospheres including less than 100 ppm CO₂, e.g. less than 50 ppm CO₂, less than 20 ppm CO₂ or less than 10 ppm CO₂. These CO₂ levels may be achieved by using a CO₂ scrubber to remove CO₂.

It may be preferred that the CO₂-free atmosphere comprises a mixture of O₂ and N₂. It may be further preferred that the mixture comprises a greater amount of N₂ than O₂ for example that the mixture comprises N₂ and O₂ in a ratio of from 50:50 to 90:10, for example from 60:40 to 90:10, for example about 80:20. Alternatively the carbon dioxide free atmosphere may be oxygen (e.g. pure oxygen).

During calcination, CO₂-free air may be flowed over the materials during heating and optionally during cooling. The flow rate of CO₂-free air may be at least 2 L/min/kg, such as between 2 and 40 L/min/kg.

Optionally, a surface modification step is carried out on the lithium nickel metal oxide material after calcination to increase the concentration of one or more elements at or near to the surface of the particles. The surface modification step may comprise contacting the lithium nickel metal oxide with a composition comprising one or more metal elements. The one or more metal elements may preferably be one or more selected from cobalt, aluminium, titanium, and zirconium.

The composition of one or more metal elements may be provided as an aqueous solution. Suitably, the one or more metal elements may be provided as an aqueous solution of salts of the one or more metal elements, for example as nitrates or sulfates of the one or more metal elements. The surface-modification step typically comprises the step of immersing or otherwise contacting the lithium nickel metal oxide particles in the aqueous solution, separating the solid and optionally drying the material. The separation is suitably carried out by filtration, or alternatively the separation and drying may be carried out simultaneously by spray-drying. The composition of one or more metal elements may also be provided as a solid powder which is dry mixed with the lithium nickel metal oxide material. Following treatment of the surface of the lithium nickel metal oxide particles the surface-modified material may be subjected to a subsequent heating step.

The process may include one or more milling steps, which may be carried out after calcination. The nature of the milling equipment is not particularly limited. For example, it may be a ball mill, a planetary ball mill or a rolling bed mill. The milling may be carried out until the particles reach the desired size. For example, the particles of the lithium nickel metal oxide material may be milled until they have a volume particle size distribution such that the D50 particle size is at least 5 μm, e.g. at least 5.5 μm, at least 6 μm or at least 6.5 μm. The particles of lithium nickel metal oxide material may be milled until they have a volume particle size distribution such that the D50 particle size is 15 μm or less, e.g. 14 μm or less or 13 μm or less.

The process of the present invention may further comprise the step of forming an electrode (typically a cathode) comprising the lithium nickel metal oxide material. Typically, this is carried out by forming a slurry of the lithium nickel metal oxide material, applying the slurry to the surface of a current collector (e.g. an aluminium current collector), and optionally processing (e.g. calendaring) to increase the density of the electrode. The slurry may comprise one or more of a solvent, a binder, carbon material and further additives.

Typically, the electrode of the present invention will have an electrode density of at least 2.5 g/cm³, at least 2.8 g/cm³ or at least 3 g/cm³. It may have an electrode density of 4.5 g/cm³ or less, or 4 g/cm³ or less. The electrode density is the electrode density (mass/volume) of the electrode, not including the current collector the electrode is formed on. It therefore includes contributions from the active material, any additives, any additional carbon material, and any remaining binder.

The process of the present invention may further comprise constructing a battery or electrochemical cell including the electrode comprising the lithium nickel metal oxide material. The battery or cell typically further comprises an anode and an electrolyte. The battery or cell may typically be a secondary (rechargeable) lithium (e.g. lithium ion) battery.

The present invention will now be described with reference to the following examples, which are provided to assist with understanding the present invention and are not intended to limit its scope.

### EXAMPLES

### Example 1: Formation of Li_{1.0}Ni_{0.92}Co_{0.08}Mg_{0.01}O₂ Using a Calcination Step at 500° C. for 4 Hours

A precursor material (Ni_{0.91}Co_{0.08}Mg_{0.01}(OH)₂, 65 g, Brunp) was mixed with anhydrous LiOH (17.1 g) using a shaker mixer in air for 10 minutes. The blended mixture was transferred to an alumina crucible (bed loading 0.8 g/cm²) and placed inside a carbolite furnace. The material was heated with a CO₂-scrubbed air gas flow of 31 L/min/kg using the following calcination profile (i) heating at a rate 5° C./min to 500° C.; (ii) holding at 500° C. for 4 hours; (iii) heating at 2° C./min ramp to 700° C.; (iv) holding at 700° C. for 2 hours. Once the calcination had finished and the temperature had cooled <150° C. the crucible was unloaded from the furnace.

The formed lithium nickel metal oxide material was found to have a composition of Li_{1.0}Ni_{0.92}Co_{0.08}Mg_{0.01}O₂ (through analysis by inductively coupled plasma optical emission spectroscopy (ICP-OES)) and to be formed from secondary particles with a D50 of 10.5 μm (by laser diffraction particle size analysis).

### Example 2: Formation of Li_{1.0}Ni_{0.92}Co_{0.08}Mg_{0.01}O₂ Using a Calcination Step at 500° C. for 6 Hours

The experiment of Example 1 was repeated with the hold time at 500° C. increased to 6 hours. The formed lithium nickel metal oxide material was found to have a composition of Li_{1.0}Ni_{0.92}Co_{0.08}Mg_{0.01}O₂ (through analysis by inductively coupled plasma optical emission spectroscopy (ICP-OES)) and to be formed from secondary particles with a D50 of 10.2 μm (by laser diffraction particle size analysis).

### Examples 3 to 6: Variation in Calcination Conditions

The experiment of Example 1 was repeated with varying calcination conditions (as shown in Table 1):

TABLE 1
a summary of the experimental conditions used in Examples 3 to 6.

| | | Bed | |
|---|---|---|---|
| Example | Thermal profile (heating rates as for | loading | Gas flow |
| no. | Ex. 1) | (g/cm²) | (L/min/kg) |
| 3 | 500° C. for 6 h and then 700° C. for 2 h | 0.8 | 31 |
| 4 | 500° C. for 8 h and then 700° C. for 2 h | 0.8 | 31 |
| 5 | 500° C. for 5 h and then 700° C. for 2 h | 0.8 | 31 |
| 6 | 500° C. for 7 h and then 700° C. for 2 h | 0.8 | 31 |

### Example 7 (Comparative Example)

A lithium nickel metal oxide material of formula Li_{1.0}Ni_{0.92}Co_{0.08}Mg_{0.01}O₂ was prepared by an analogous route to the described in Example 1, with the following calcination profile:

(i) heating at a rate 5° C./min to 450° C.; (ii) holding at 450° C. for 2 hours; (iii) heating at 2° C./min ramp to 700° C.; (iv) holding at 700° C. for 6 hours. The calcination was carried out in an alumina crucible with a bed loading of 1.3 g/cm² and with a CO₂-scrubbed air gas flow rate of 20 L/min/kg.

### Powder X-Ray Diffraction (PXRD)

The material produced in Example 1 and Example 2 was analysed by PXRD which showed each material to have an α-NaFeO₂-type structure.

The crystallite size of materials produced by the calcination profiles of Examples 1 to 7 was determined as follows. PXRD data was collected in reflection geometry using a Bruker AXS D8 diffractometer using Cu Kα radiation (λ=1.5406+1.5444 Å). A dataset was collected between 2θ=10-130° in 0.02° steps. Phase identification was conducted using Bruker AXS Diffrac Eva V5 (2019) with reference to the PDF-4+ database, to ensure that all of the observed scattering could be assigned to known crystal structures. Rietveld refinement was performed using Bruker-AXS Topas 5 between 2θ=17-70° where the instrumental parameters were determined using a fundamental parameters approach using reference data collected from NIST660 LaB₆. The crystallite sizes of the assigned phase have been calculated using the volume weighted column height LVol-IB method.

TABLE 2
Crystallite sizes determined through a Reitveld
refinement of the PXRD data collected on the
material produced by Examples 1, 2 and 4 to 7.

| | Crystallite Size |
|---|---|
| Example | (nm) |
| 1 | 154 |
| 2 | 102 |
| 4 | 175 |
| 5 | 125 |
| 6 | 150 |
| 7 (comparative) | 75 |

### Example 8—In Situ Variable Temperature x-Ray Diffraction

A mixture of Ni_{0.91}Co_{0.08}Mg_{0.01}(OH)₂ and LiOH (in an equivalent ratio to Example 1) was heated in a variable temperature x-ray diffractometer under an atmosphere of 80% nitrogen:20% oxygen to study the formation of intermediate phases during a calcination profile of (i) heating at a rate 5° C./min to 500° C.; (ii) holding at 500° C. for 8 hours; (iii) heating at 2° C./min ramp to 700° C.; (iv) holding at 700° C. for 2 hours; (v) cooled to 30° C.

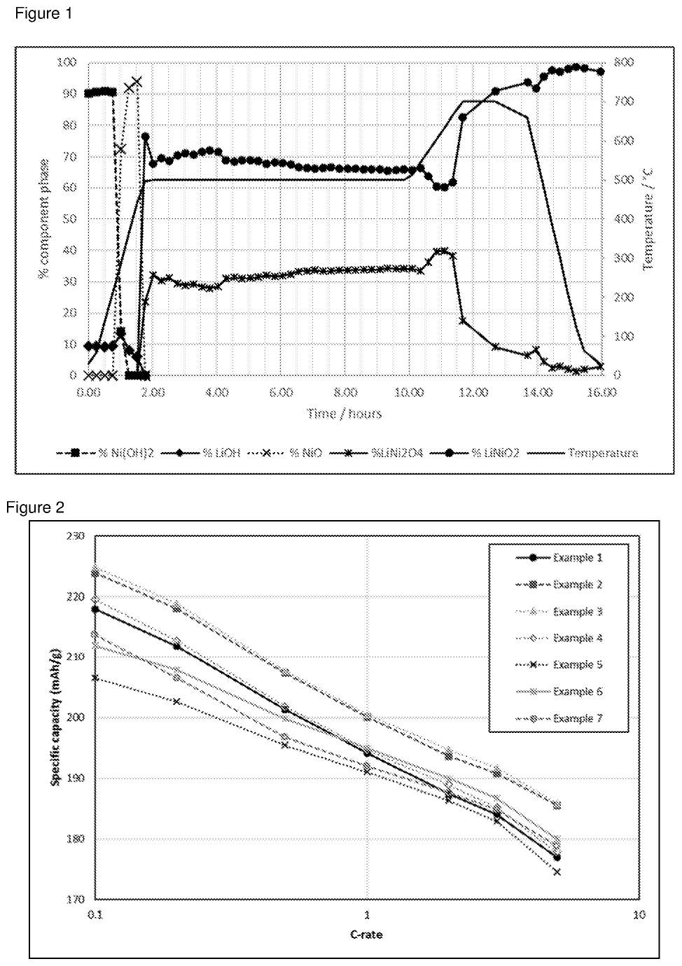

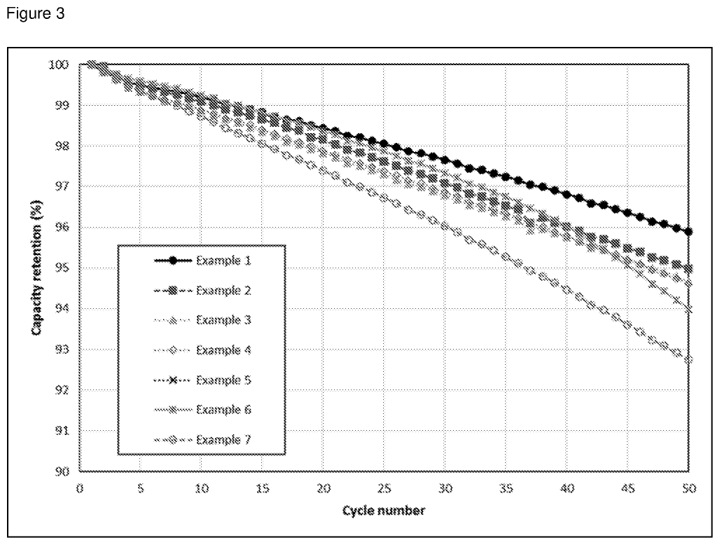

FIG. 1 shows the changing phases of the material during the calcination process. This shows that heating to a temperature of 500° C. leads to the disappearance of the Ni(OH)₂ and LiOH phases and the formation of intermediate lithium nickel oxide type phase/s. During the hold period for 8 hours at 500° C., the relative amounts of the two modelled intermediates stays consistent. After holding at 500° C. for a period of 8 hours, an increase in temperature above 600° C. leads to rapid conversion to the desired LiNiO₂ structure.

The in situ XRD study indicated that holding at 500° C. during calcination enabled rapid transformation to the desired LiNiO₂ structure at higher temperatures greater than 600° C.

### Electrochemical Testing

### Testing Protocol

Electrodes were prepared by blending 94% wt of the lithium nickel metal oxide active material, 3% wt of Super-C as conductive additive and 3% wt of polyvinylidene fluoride (PVDF) as binder in N-methyl-2-pyrrolidine (NMP) as solvent. The slurry was added onto a reservoir and a 125 μm doctor blade coating (Erichsen) was applied to aluminium foil. The electrode was dried at 120° C. for 1 hour before being pressed to achieve a density of 3.0 g/cm³. Typically, loadings of active is 9 mg/cm². The pressed electrode was cut into 14 mm disks and further dried at 120° C. under vacuum for 12 hours.

Electrochemical test was performed with a CR2025 coin-cell type, which was assembled in an argon filled glove box (MBraun). Lithium foil was used as an anode. A porous polypropylene membrane (Celgard 2400) was used as a separator. 1M LiPF₆ in 1:1:1 mixture of ethylene carbonate (EC), dimethyl carbonate (DMC) and ethyl methyl carbonate (EMC) with 1% of vinyl carbonate (VC) was used as electrolyte.

The cells were tested on a MACCOR 4000 series using C-rate and retention tests using a voltage range of between 3.0 and 4.3 V. The C-rate test charged and discharged cells at 0.1 C and 5 C (0.1C=200 mAh/g). The capacity retention test was carried out at 1 C with samples charged and discharged over 50 cycles. DCIR resistance was measured during the capacity retention test at full state of charge using alternating 10 s and 1 s pulses at 3 C every 5 cycles, respectively. Both tests were carried out at 23° C.

### Electrochemical Results

FIG. 1 shows the results of C-rate testing of the materials produced in Examples 1 to 7. Table 3 shows the 0.1 C discharge capacity of the materials produced in Examples 1 to 7. This data shows that at least equivalent material performance is achieved by each of the Examples involving a hold at 500° C. in comparison to the comparative Example 7, despite significantly less time at high temperature at a temperature greater than 650° C. The data also shows that a six hour hold at 500° C. provides an enhancement in electrochemical performance at a range of C-rates and provides the highest discharge capacity.

TABLE 3
0.1 C discharge capacity results for Examples 1 to 7

| Sample | 0.1 C discharge capacity |
|---|---|
| Example 1 | 218 |
| Example 2 | 224 |
| Example 3 | 225 |
| Example 4 | 219 |
| Example 5 | 206 |
| Example 6 | 212 |
| Comp. example 7 | 214 |

FIG. 2 shows the results of discharge capacity retention testing of the materials produced in Examples 1 to 7. Table 4 shows the results of discharge capacity retention testing of Examples 1 to 7. This data shows that at least equivalent material performance is achieved by each of the Examples in comparison to the comparative Example 7. The highest 1^{st} cycle capacity is achieved with the material produced by a method involving a six hour hold at 500° C. The discharge capacity after 50 cycles was higher for each of the examples produced by a method involving a 500° C. than that produced by the method of comparative Example 7.

TABLE 4
Results of capacity retention testing of Examples 1 to 7.

| | Cycle life | | |
|---|---|---|---|
| Sample | 1 C cycle 1 (mAh/g) | 1 C cycle 50 (mAh/g) | Retention (%) |
| Example 1 | 199 | 191 | 96 |
| Example 2 | 204 | 193 | 95 |
| Example 3 | 203 | 192 | 95 |
| Example 4 | 198 | 187 | 94 |
| Example 5 | 193 | 181 | 94 |
| Example 6 | 197 | 185 | 94 |
| Comp. | 192 | 178 | 93 |
| Example 7 | | | |

Table 5 shows the initial Direct Current Internal Resistance (DCIR) parameters for Examples 1, 2 and 4-7. The samples produced using a calcination with a 500° C. hold had a reduced internal resistance in comparison with comparative Example 7. A six hour hold at 500° C. yielded material with the lowest DCIR value. The DCIR values indicated that a crystallite size in the range 90 to 200 nm yielded a lower internal resistance value than that observed for a sample with a crystallite size of <90 nm (comparative Example 7).

TABLE 5
DCIR parameters (1 s and 10 s)

| Sample | Initial DCIR 10 s (Ohm) | Initial DCIR 1 s (Ohm) |
|---|---|---|
| Example 1 | 17.4 | 14.5 |
| Example 2 | 15.3 | 11.5 |
| Example 4 | 18.0 | 16.1 |
| Example 5 | 17.0 | 13.3 |
| Example 6 | 17.0 | 13.3 |
| Comp. Example 7 | 20.4 | 17.9 |

1. A process for producing a lithium nickel metal oxide material having a composition according to Formula 1:
LiₐNiₓCO_{y}A_{z}C_{2+b} Formula 1
in which:
A is one or more of Al, V, Ti, B, Zr, Cu, Sn, Cr, Fe, Ga, Si, Zn, Mg, Sr, Mn, and Ca;
0.8≤a≤1.2
0.7≤x<1
0<y≤0.3
0≤z≤0.2
−0.2≤b≤0.2
x+y+z=1
the process comprising the steps of:
(i) mixing a nickel metal hydroxide precursor with a lithium-containing compound; and
(ii) calcining the mixture to form the lithium nickel metal oxide material; wherein the calcination comprises a first calcination step which comprises heating at a temperature of between about 460 DC and about 540° C. for a period of between three and ten hours, and a subsequent second calcination step which comprises heating to a temperature greater than about 600° C. for a od of between 30 mins and 4 hours.

2. The process according to claim 1, wherein A is one or more of Al, V, Ti, B, Zr, Cu, Sn, Cr, Fe, Ga, Si, Zn, Mg, Sr, and Ca.

3. The process according to claim 1, wherein A is Al and/or Mg.

4. The process according to claim 1, wherein 0.8≤x<0.95 and 0<y≤0.2.

5. The process according to claim 1, wherein the lithium-containing compound is lithium hydroxide.

6. The process according to claim 1, wherein the second calcination step is at a temperature greater than about 650° C.

7. The process according to claim 1, wherein the second calcination step is at a temperature between 600° C. and 800° C.

8. The process according to claim 1, wherein the second calcination step is carried out for a period of 1 to 4 hours.

9. The process according to claim 1, wherein the process further comprises the step of modifying the surface of the lithium nickel metal oxide material.

10. The process according to claim 1, wherein the process further comprises the step of milling the lithium nickel metal oxide material.

11. The process according to claim 1, further comprising the step of forming an electrode comprising the lithium nickel metal oxide material.

12. The process according to claim 11, further comprising the step of constructing a battery or electrochemical cell including an electrode comprising the lithium nickel metal oxide material.

13. A particulate lithium nickel metal oxide material having a composition according to Formula 2:
Liₐ₁Niₓ₁Co_{y1}A_{z1}O_{2+b1} Formula 2
in which:
A is one or more of V, Ti, B, Zr, Cu, Sn, Cr, Ga, Si, Mg, Sr and Ca;
0.8≤a1≤1.2
0.7≤x1<1
0<y1≤0.3
0<z1≤0.2
−0.2≤b1≤0.2
x1+y1+z1=1
wherein the particulate lithium nickel metal oxide has a crystallite size in the range of an including 90 to 200 nm.

14. The particulate lithium nickel metal oxide material according to claim 13, wherein A is Mg and optionally one or more of V, Ti, B, Zr, Cu, Sn, Cr, Ga, Si, Sr and Ca.

15. The particulate lithium nickel metal oxide material according to claim 13, wherein A is Mg.

16. The particulate lithium nickel metal oxide material according to claim 13, wherein 0.8≤x1<1, 0<y1<0.2, and 0<z1<0.2.

17. The particulate lithium nickel metal oxide material according to claim 13, wherein 0.85≤x1<1, 0<y1<0.15, and 0<z1<0.15.

18. The particulate lithium nickel metal oxide material according to claim 13 wherein the crystallite size is 90 to 160 nm, or 90 to 120 nm.

19. An electrode comprising a particulate lithium nickel metal oxide according to Formula 2 or a particulate lithium nickel metal oxide obtainable by a process according to Process 1, wherein
Process 1 comprises the steps of:
(i) mixing a nickel metal hydroxide precursor with a lithium-containing compound; and
(ii) calcining the mixture to form the lithium nickel metal oxide material; wherein the calcination comprises a first calcination step which comprises heating at a temperature of between about 460° C. and about 540° C. for a period of between three and ten hours and a subsequent second calcination step which comprises heating to a temperature greater than about 600° C. for a period of between 30 mins and 4 hours so as to give rise to a particulate lithium nickel metal oxide having the formula LiₐNiₓCO_{y}A_{z}C_{2+b},
in which:
A is one or more of Al, V, Ti, B, Zr, Cu, Sn, Cr, Fe, Ga, Si, Zn, Mg, Sr, Mn, and Ca;
0.8≤a≤1.2
0.7≤x<1
0<y≤0.3
0≤z≤0.2
−0.2≤b≤0.2
x+y+z=1; and
Formula 2 is
Liₐ₁Niₓ₁Co_{y1}A_{z1}O_{2+b1}
in which:
A is one or more of V, Ti, B, Zr, Cu, Sn, Cr, Ga, Si, Mg, Sr and Ca;
0.8≤a1≤1.2
0.7≤x1<1
0<y1≤0.3
0<z1≤0.2
−0.2≤b1≤0.2
x1+y1+z1=1
wherein the particulate lithium nickel metal oxide has a crystallite size in the range of an including 90 to 200 nm.

20. An electrochemical cell comprising an electrode according to claim 19.
